(19) United States
(12) Patent Application Publication
(10) Pub. No.: US 2006/0041323 A1
(43) Pub. Date: Feb. 23, 2006

(54) Method of inputting same data to a plurality of programmable logic controllers

(76) Inventor: Li-Wen Chai, Taoyuan (TW)

Correspondence Address: RABIN & BERDO, P.C., Suite 500, 1101 14 Street, N. W., Washington, DC, 20005, US

(21) Appl. No.: 10/968,134

(22) Filed: Oct. 20, 2004

(30) Foreign Application Priority Data
Aug. 20, 2004 (TW) 93125289

(51) Int. Cl. G05B 11/01; G05B 19/42

(52) U.S. Cl. 700/18; 700/86; 700/23; 700/87

(57) ABSTRACT

A method of inputting same data into a plurality of programmable logic controllers (PLCs) is disclosed, in which to-be-inputted data is first inputted to a first PLC among the plurality of PLCs and the inputted data in the first PLC are then written first into a second PLC among the plurality of PLCs by forming a program packet, transferring the data into the second PLC and automatically executing the program packet in the second PLC. In the same manner, other PLCs among the plurality of PLCs may be inputted with the same data. Therefore, the data inputting process into the plurality of PLCs may be much simplified and thus the process time may be considerably reduced.

### BACKGROUND OF THE INVENTION

1. Field of Invention

The invention relates to a method of inputting data into a device, and particularly to a method of inputting the same data to a plurality of programmable logic controllers (PLCs).

2. Related Art

With the progress of automated industry, there is a trend of using a programmable logic controller in controlling some output devices, such as a relay and an indicator light, in which a user thereof edits instructions and the PLC generates control logics for control of these output devices according to the instructions edited and stored in its memory module.

FIG. 1 is a schematic illustration of a data writes operation in a memory module, internal to such a PLC. Generally, the memory may be divided into a program division 101, a data register division 102, a system parameters division 103 and other device divisions. To be properly used in any application, the parameters in the memory should be changed as desired. Therefore, when a PLC is required to have different system parameters or new programs, these parameters and programs are generally manually inputted into the PLC through a specific tooling software. When a plurality of PLCs needs to have these parameters and programs, each of them should be inputted therewith one by one. For example, an operation instruction 1 among the edited instructions executes a data write into the program division 101, an operation instruction 2 in the instructions executes a data write into the system parameters division 102, and an operation instruction 3 in the instructions executes a data write into the data register division 103 and the like. In case 600 PLCs are to be updated with the internal parameters and data, each of the PLCs should be undertaken with such parameters. Data inputting operations should be done with respect to divisions with a number of over 10 in the memory in each of the PLCs. Apparently, this updating and setting process is quite troublesome and time consuming.

Therefore, there is a need to provide a simplified method of inputting the same data into a plurality of PLCs.

### SUMMARY OF THE INVENTION

It is, therefore, an object of the invention to provide a method of inputting the same data into a plurality of PLCs, in which to-be-inputted data are first inputted in a first PLC among the plurality of PLCs. The inputted data in the first PLC are then written into a second PLC among the plurality of PLCs by forming a program packet, transferring the data into the second PLC and automatically executing the program packet in the second PLC. In the same manner, other PLCs among the plurality of PLCs may be inputted with the same data. Therefore, the data inputting process into the plurality of PLCs may be much simplified and thus the process time may be considerably reduced.

To achieve the aforementioned object, the method of inputting the same data into a plurality of PLCs according to a first embodiment of the invention comprises the steps of obtaining a plurality of addresses corresponding to a plurality of memory divisions in a memory in a first PLC among the plurality of PLCs, inputting the data into the first PLC at the plurality of memory divisions thereof, preparing a program packet comprising the data and the plurality of addresses, transferring the data into a second PLC among the plurality of PLCs at a plurality of memory divisions therein corresponding to the plurality of addresses, executing the program packet in the second PLC and repeating the last two steps with respect to the other PLCs among the plurality of PLCs, so that the same data may be inputted into the plurality of PLCs.

To achieve the aforementioned object, the method of inputting the same data into a plurality of PLCs according to a second embodiment of the invention comprises the steps of obtaining a plurality of sets of a starting address and an ending address corresponding to a plurality of memory divisions in a memory in a first PLC among the plurality of PLCs, inputting the data into the first PLC among the plurality of PLCs at the plurality of memory divisions thereof according to the plurality sets of the starting address and the ending address; determining if the data have been inputted in the first PLC; preparing a program packet comprising the plurality of sets of the starting address and the ending address when the data are determined as being inputted into the first PLC; transferring the program packet into a second PLC among the plurality of PLCs; executing the program packet in the second PLC among the plurality of PLCs and repeating the last two steps with respect to the other PLCs among the plurality of PLCs until all the PLCs may be inputted with the same data.

By use of the method of inputting the same data into a plurality of PLCs, a process of data inputting into a plurality of PLCs may be much simplified and the time consumed therein is considerably reduced.

The features and implementations of the invention will be explained in detail by way of preferred embodiments in connection with drawings, as follows.

### BRIEF DESCRIPTION OF THE DRAWINGS

The invention will become more fully understood from the detailed description given hereinbelow illustration only and thus does not limit the invention, wherein:

FIG. 1 is a schematic illustration of a prior data writing operation into a programmable logic controller (PLC);

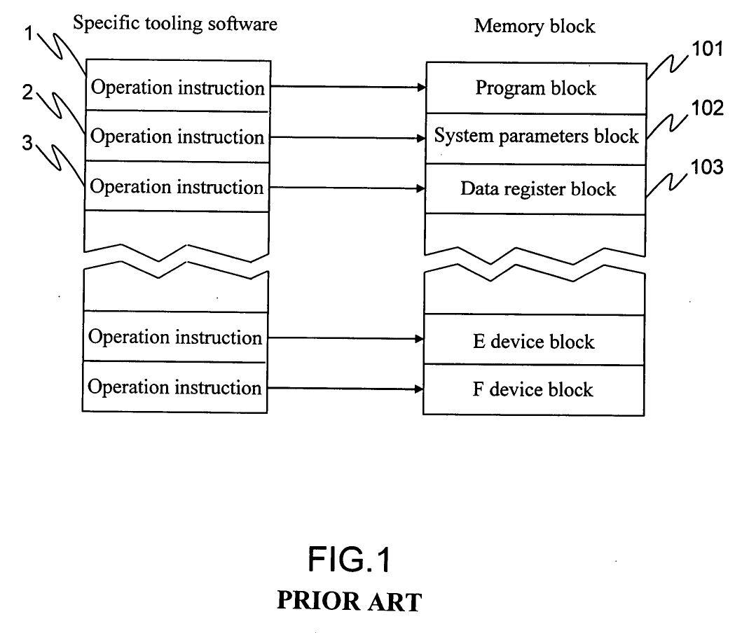

FIG. 2 is a flowchart of a method of inputting the same data into a plurality of PLCs of a first embodiment according to the invention;

FIG. 3 is a flowchart of a method of inputting the same data into a plurality of PLCs of a second embodiment according to the invention; and

FIG. 4 is a schematic illustration of a data writing operation into a PLC according to the invention.

### DETAILED DESCRIPTION OF THE INVENTION

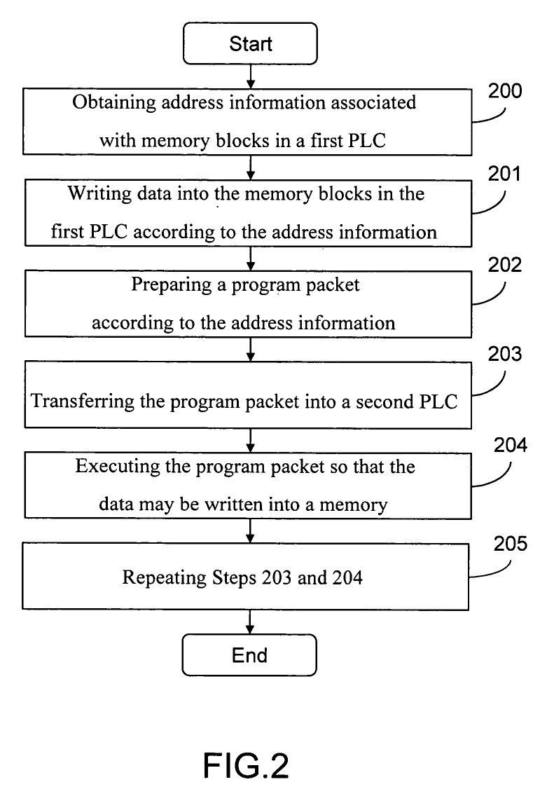

Referring to FIG. 2, a flowchart of a method of inputting same data into a plurality of PLCs of a first embodiment according to the invention is illustrated therein. First, obtaining a plurality of addresses corresponding to a plurality of memory blocks of a memory in a first PLC of the PLCs (200). For example, the memory block having the addresses 0000H-7FFFH in the memory of the PLC is designated as a program block and the addresses 0000H-7FFFH are recorded. Next, inputting data into the plurality of memory blocks of the memory in the PLC (201), i.e., inputting the data into the memory block having the addresses of 0000H-7FFFH in the above exemplary case. Preparing a program packet comprising the addresses corresponding to the plurality of memory blocks and the data stored in the plurality of memory blocks corresponding to the plurality of addresses (202), wherein the program packet is a packet being automatically executed with a data writing operation according to the addresses. Transferring the program packet into a second PLC among the plurality of PLCs (203), wherein transferring may be achieved by coupling a serial communication (COM) port in the first PLC to a serial COM port in the second PLC. Thereafter, executing the program packet in the second PLC (204). Then, repeating Steps 203 and 204 with respect to other PLCs among the plurality of PLCs so that the data may be inputted into the plurality of memory blocks (205).

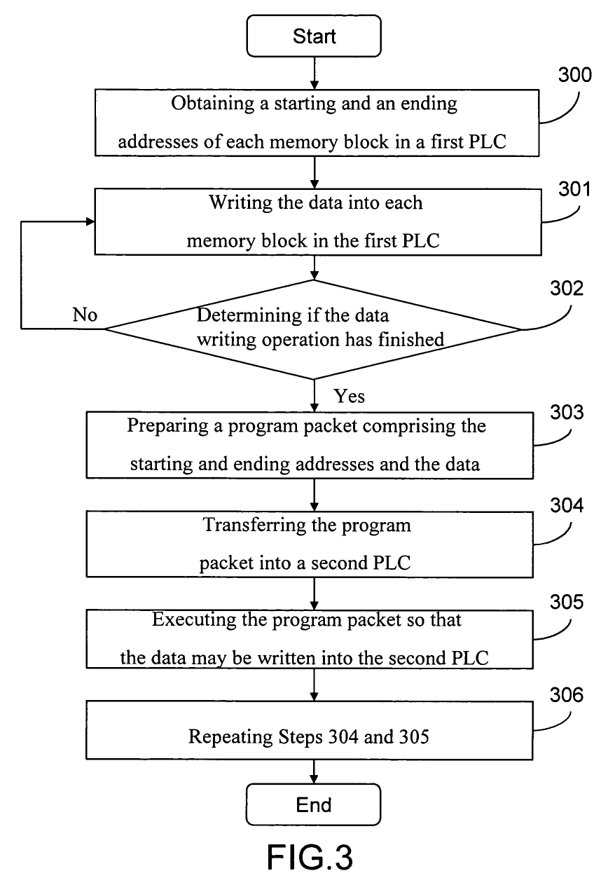

Next, referring to FIG. 3 where a flowchart of a method of inputting the same data into a plurality of PLCs of a second embodiment according to the invention is illustrated. First, obtaining a plurality of sets of a starting address and an ending address corresponding to a plurality of memory blocks in a first PLC among the plurality of PLCs (300). For example, the addresses 0000H and 7FFFH in the memory of the first PLC are the starting and ending addresses of a program block of the memory of the first PLC respectively. Inputting the data into the plurality of memory blocks in the first PLC according to the obtained plurality of the starting and ending addresses. Determining if the data have been inputted into the first PLC (302), i.e., determining if a current address corresponding to a current writing operation into the memory of the first PLC is a last ending address among the plurality sets of the starting and the ending addresses. Preparing a program packet comprising the plurality sets of the starting address and the ending address and the data when the current address is determined to be the last ending address (303), wherein the program packet is a packet being automatically executed with a data write operation according to the plurality of sets of the starting and the ending addresses. Transferring the program packet into a second PLC among the plurality of PLCs (304), wherein the transferring may be achieved by coupling a serial communication (COM) port of the first PLC to a serial COM port of the second PLC. Thereafter, executing the program packet in the second PLC so that the data may be inputted into the second PLC in a plurality of memory blocks specific by the plurality sets of starting and ending addresses (305). Then, repeating Steps 304 and 305 with respect to the other PLCs among the plurality of PLCs (306) so that the data may be written into the other PLCs among the plurality of PLCs. If the current address is determined not to be the last ending address, the corresponding process goes back to Step 301.

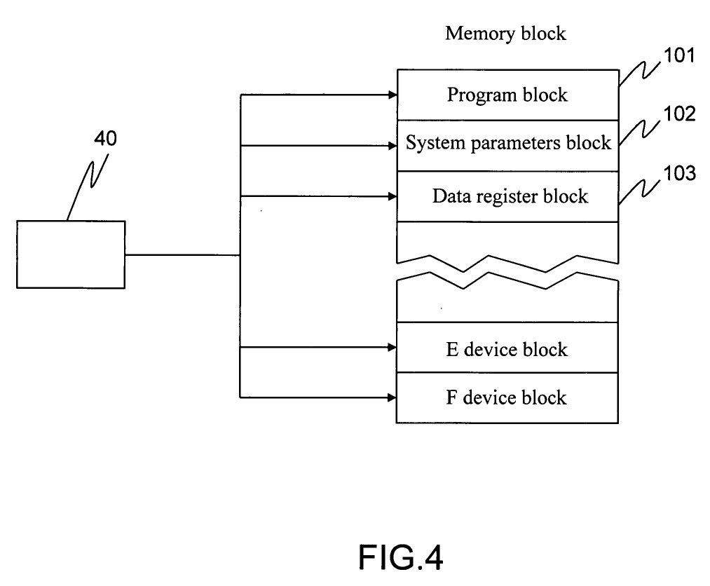

Referring to FIG. 4, a data write into a memory of a target PLC from a sample PLC according to the invention is illustrated therein. First, a user first obtains a plurality of addresses corresponding to a plurality of memory blocks of a memory in a sample PLC and then inputs the data into a program block 101, a system parameters block 102, a data register block 103 and other device blocks among the plurality of memory blocks. After the data write operation is finished in the sample PLC, the data and the plurality of addresses are recorded and made as a program packet, wherein the program packet is a packet being automatically executed according to the plurality of addresses in the program packet. Then, the program packet is transferred into the target PLC. Thereafter, the program packet is automatically executed in the target PLC so that the data in the program packet are written into the memory of the target PLC. Accordingly, all data may be written into the corresponding memory block in the target PLC. In this manner, the data writing into a PLC may be appropriately and advantageously applied in case a number of PLCs are to be inputted with the same data by use of the sample PLC and the corresponding data write operation.

In conducting this writing operation with respect to the target PLC, a serial communication interface such as RS-232, RS-485 and RS-224 may be provided in the sample and target PLC respectively so that the first PLC may transfer the program packet to the PLC and the succeeding data writing will thus be possible.

Therefore, no matter which type of the PLCs are selected, any PLC used among a plurality of PLCs needing to have the same data may be inputted with the same data according to the method provided in the invention, where the data are first inputted into a first PLC at memory blocks associated thereof and the data are then contained in a program packet executed in the other PLCs of the plurality of PLCs. Therefore, the method provided in the invention greatly simplifies data inputting operation into a plurality of PLCs, especially in case a great number of PLCs are to be inputted with the same data, since only one PLC is required to be inputted data and other PLCs may be inputted data simply by automatically executing the data program therein.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

1. A method of inputting same data into a plurality of programmable control logic controllers (PLCs), comprising the steps of:
(a) obtaining a plurality of addresses corresponding to a plurality of memory blocks of a memory in a first PLC among the plurality of PLCs;
(b) inputting data into the memory in the first PLC at the plurality of memory blocks according to the plurality of addresses;
(c) preparing a program packet comprising the plurality of addresses corresponding to the plurality of memory blocks and the data stored in the plurality of memory blocks;
(d) transferring the program packet into a second PLC among the plurality of PLCs;
(e) executing the program packet in the second PLC so that the data may be inputted into a plurality of memory blocks corresponding to the plurality of addresses in a memory in the second PLC; and
(f) repeating the steps (d) and (e).

2. The method as recited in claim 1, wherein the program packet is a packet being automatically executed in any PLC with a data write operation according to the plurality of addresses.

3. The method as recited in claim 1, wherein the transferring step is executed through a serial data transmitting manner.

4. A method of inputting same data into a plurality of programmable logic controllers (PLCs), comprising the steps of:
obtaining a plurality sets of a starting address and an ending address corresponding to a plurality of memory blocks in a memory in a first PLC among the plurality of PLCs;
inputting the same data into the plurality of memory blocks in the first PLC according to the plurality of addresses;
preparing a program packet comprising the plurality sets of the starting address and the ending address and the data;
transferring the program packet into a second PLC among the plurality of PLCs; and
executing the program packet so that the data may be inputted into the second PLC at a plurality of memory blocks corresponding to the plurality sets of the starting address and the ending addresses.

5. The method as recited in claim 4, wherein the program packet is a packet being automatically executed according to the plurality sets of the starting address and the ending address.

6. The method as recited in claim 4, wherein the transferring step is executed through a serial data transmitting manner.
